(19) United States
(12) Patent Application Publication
(10) Pub. No.: US 2004/0255030 A1
(43) Pub. Date: Dec. 16, 2004

(54) Simultanceous provisioning of two or more services with different architectures in a communication network

(76) Inventor: Jyrki Sillanpaa, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/478,913

(22) PCT Filed: May 28, 2002
(86) PCT No.: PCT/IB02/02948

(30) Foreign Application Priority Data
May 31, 2001 (GB) 0113240.6

(51) Int. Cl. G06F 15/16

(52) U.S. Cl. 709/228

(57) ABSTRACT

In a communication system a plurality of services can be provided for a user in a session. At least two of said services can be provided based on different service architectures. In the method a user is first provided with a session. A control entity is provided with information identifying the session and also with information identifying a service to be provided for the user during the session. Said identity information is processed at the control entity to verify if information associated with provision of services in the session is stored at the control entity. The provision of the service is controlled based on the results of the processing. In an embodiment services or groups of services are provided with unique identifiers. The service provisioning is then controlled based on said identifiers.

### FIELD OF THE INVENTION

The present invention relates to provision of services for a user of a communication system.

### BACKGROUND OF THE INVENTION

A communication system can be seen as a facility that enables a user thereof to communicate with one or more other entities such as another user equipment and/or nodes implemented within the communication system. The communication may comprise, for example, communication of voice, data, multimedia and so on.

A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based on needs to be defined to enable communication by means of the system.

The users of a communication system may be provided with a possibility to use various services. The services are typically provided by entities referred to as service providers. The services provided for a user may comprise any service than can be provisioned by means of the communication system. For example, and without any intention to limit to these, a user may be provided with a possibility to make and receive calls, to browse a data networks (e.g. the Internet), to send and receive emails or other text messages, to receive various types of content from a server (e.g. video data or other image or voice data), to attend chat rooms, to use various other value added services such as the presence service, location based services, or to attend games, competitions, voting services, and so on.

The service providers may provide services based on different service architectures. For example, the service provision may be based, without limiting to these, on e.g. an intelligent network (IN) architecture, a third generation (3G) multimedia service architecture, a service node based architecture, or any other service architecture. In some service architectures the service provisioning is at least partially handled by of the user equipment.

It is possible that a user is provided with more than one service during a session. In such a case it is important that the services do not cause any conflict situations or otherwise do not disturb the execution of each other. This is an especially important concern when more than one service architecture can be used for the provisioning of services in a communication system.

In the prior art the interaction of different services has been taken into account when generating a new service architecture. That is, any new architecture or feature is created so that it does not disturb the already existing features. The introduction of new architectures has typically been controlled by international organisations such as the International Telecommunication Union (ITU), the Internet Engineering Task Force (IETF) and so on.

However, the inventor has found that control of interaction of services is becoming an increasing problem in service provisioning. A reason for this is that the service providers would like to have faster and more flexible ways to introduce new services. The conventional way of getting approvals from the governing bodies may be way too slow and/or heavy routine to meet the requirements for quick launch of a new service product and the decreasing lifecycles of services. This may be especially true for service providers who are independent from the network operators. In highly competitive markets with only minor distinctions in the products it may also be advantageous be the first provider of a new service.

The problem associated with interaction of services may become even more serious in systems such as the so called ‘all IP’ arrangements. These systems will allow the service providers to more freely introduce new service architectures and/or features in the system. In addition, features such as provision of more customised services may need to be enabled for the service providers. The services may also be provided by new type of service providers such as operators that provide only services but no hardware and so on. Aspects such as capabilities and speed of provisioning and customising services is also believed to be an important aspect of the future communication networks.

Thus, these requirements mean that the communication system must be able to provide a substantially flexible service provisioning such that many different kinds of architectures for different kinds of services can be provided while avoiding problems caused by poor interaction between the services.

### SUMMARY OF THE INVENTION

Embodiments of the present invention aim to address one or several of the above problems.

According to one aspect of the present invention, there is provided a method in a communication system for provisioning of services, wherein at least two of said services is provided based on different service architectures, the method comprising: providing a user with a session; providing a control entity with information identifying the session and information identifying a service to be provided for the user during the session; processing said identity information at the control entity to verify if information associated with provision of services in the session is stored at the control entity; and controlling the provision of the service based on the processing.

According to another aspect of the present invention there is provided a communication system wherein at least two different service architectures are used for provisioning of services for users of the system, comprising: storage means for storing information that associates with provisioning of services in a session; and means for processing information that associates with a session provided for a user and information that associates with a service provisioned in said session, wherein said processing means is adapted to verify if such information can be found from the storage means that associates with said session provided for the user and/or said service provisioned in said session.

According to another aspect of the present invention there is provided a method of providing a plurality of services in a communication system for a user of the communication system, the method comprising: provision each of the services with a unique identifier; and determining based on information of said unique identifiers if a service can be provided for a user.

According to another aspect of the present invention there is provided a communication system adapted to provide a plurality of services for a user thereof, wherein the provisioning of at least two of said services is based on different service architectures and each of the services is provided with a unique identifier.

In a more specific embodiment provision of the service in the session is denied based on the results of the processing.

Said service may be provided at the same time with provision of at least one other service. One or more of the features of said at least one other service may already be executed at the time when the control entity is provided with said information.

Said information associated with provision of services may comprise rules that are defined by analysing the service and the at least one other service. Said information may indicate a conflicting situation that may occur during execution of the service and at least one other service in the session. Said information associated with provision of services may be updated when a new service is made available for the user or an existing service is changed. Said information associated with provision of services may be updated adaptively in response to events in a session.

The control entity may communicate control information with a higher level control entity.

A timer function may be provided for monitoring the duration of provisioning of a service.

The embodiments of the invention may provide an improved solution for handling service interaction. The embodiments may enable service interaction between several service architectures. Introduction of new services and/or features may become easier to implement. The risk for faulty operation caused by situation where colliding services are run at the same time may be reduced. The proposed solution is believed to suit well for the data network environments such as packet data networks.

### BRIEF DESCRIPTION OF THE DRAWINGS

For better understanding of the present invention, reference will now be made by way of example to the accompanying drawings in which:

FIG. 1 shows an embodiment of the present invention; and

FIG. 2 is a flowchart illustrating the operation of one embodiment of the present invention.

### DESCRIPTION OF PREFERRED EMBODIMENTS OF THE INVENTION

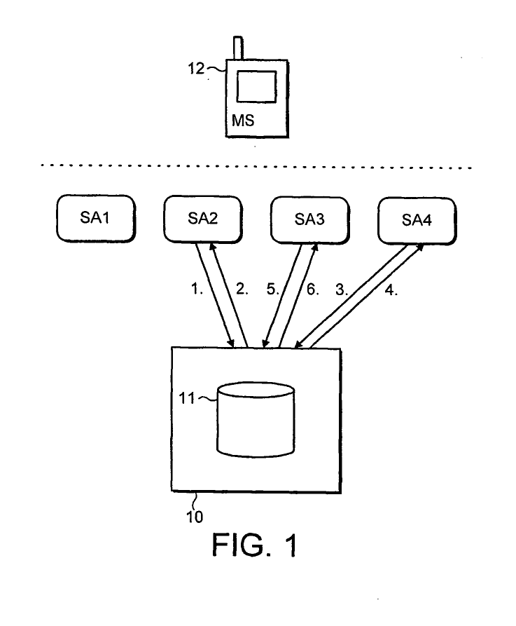

Reference is made to FIG. 1 which showing an interaction control entity 10 and four different service architectures SA1 to SA4. The service architectures provide a user equipment 12 with services by means of a communication system. Some of the service provision entities SA1 to SA4 may be located behind so called untrusted network elements.

Any communication system can be used for the service provisioning for the users of the services. The person skilled in the art is familiar with various appropriate communication systems and the elements of such systems. Therefore the elements are omitted from FIG. 1 and are not described in detail. It is sufficient to note that in accordance with an embodiment of the present invention a communication network may be adapted to provide wireless communication for the user equipment 12. Such as system may comprise a base transceiver station (BTS) or similar access entity for serving mobile stations (MS) or similar user equipment (UE). The communication between the user equipment and the elements of the communication network can be based on an appropriate communication protocol. An example of these is the session initiation protocol (SIP).

The operation of the various elements of a communication system can be controlled by one or several control entities of the system. The various control entities may be interconnected. One or more gateway nodes may also be provided for connecting the one network to other networks. The other networks may be based on different standards.

In a preferred embodiment the node 10 provides a centralised point for service interaction control such that the interaction of a plurality of services is controlled during execution of the services. The services are provided by the plurality of service providers and based on a plurality of different service architectures or environments. The services may be provided, for example, based on architectures such as IN (Intelligent Network) or CAMEL (Customised Applications for Mobile network Enhanced Logic), IPSA (Internet Protocol based Service Architecture), service node based architecture such as the APSE (Application Server Architecture), OSA (Open service Access) architecture, Parlay based architecture, a user equipment based architecture, and so on. The service provisioning typically includes use of one or more communication protocols. This protocol typically depends on the service provisioning architecture.

In FIG. 1 the user of the service is shown to comprise a mobile station 12. The user equipment may be used for execution of features of more than one of the services SA1 to SA4 during a session. For example, the user may browse in an IP based data network, have a simultaneous voice call over a circuit switched telephone network and/or use e.g. banking services or other services requiring high security. It shall be appreciated that the term “session” refers to any communication media established for the user equipment. The communication may comprise, without limiting to these, use of services such as call, text message, image message, data (e.g. web browsing), instant messaging or multimedia services and so on.

Each of the sessions can be identified by means of a unique identifier. The identifier is typically created when a new session starts. This identifier can be transferred to entities providing the service(s). The session identifiers are transferred based on appropriate standards and protocols, e.g. the session initiation protocol (SIP) and so on.

The interaction control is based on rules for the interaction between various services. The rules may be defined by any appropriate entity and stored in storage means 11 of the node 10. The rules may be defined internally or externally to the communication system. The rules may be defined e.g. by an operator of the communication system that is used for the communication during the service provisioning or by an external body providing overall control instruction and/or protocols for communication system.

The arrangement may be such that a service provider must ask for permission from the node 10 before the provider is enabled to start a new service in a session with the user equipment 12. In a basic embodiment the node 10 may then either allow or reject the execution of the service based on the rules. That is, if the rules indicate that the later service may disturb execution of an earlier service, the permission to initiate execution of the later service will be denied by the node 10.

The rules can be defined by various manners. A possibility is to study the interaction between various services beforehand and to defined the rules based on this study. More particularly, a service interaction scheme or view may then be built to define those services that are allowed to be executed in parallel, and/or those services that are allowed to be executed sequentially and those services that in general are allowed/are not allowed at all in a single session and so on.

The service interaction scheme may be updated every time a new service is added or an existing service is updated. Every service concept is preferably provided with an access to the service interaction view. The service view may be distributed dynamically. According to an alternative the information is provided by means of a centralised information point from where up-to-date information can be asked by the service providers.

The service providers provide the interaction control node 10 with information regarding the start of the provision of a service. The service providers may also provide information regarding the end of the service provision.

In accordance with an embodiment the service provider provides the interaction control node 10 with information regarding the session in which a service is indented to belong to. This information is preferably provided each time before the initiation of the execution of the features of the service. This information may be e.g. in the form of a global or local session identifier.

Information regarding the service the service provider intends to start may be provided based on a unique name of each service. Each service is provided with a unique service identifier (ID) for enabling the scheme to distinguish between the different services. The service identifier may be global or in use within a substantially large communication system. However, local identifiers may also be used e.g. in closed or otherwise substantially small communication systems.

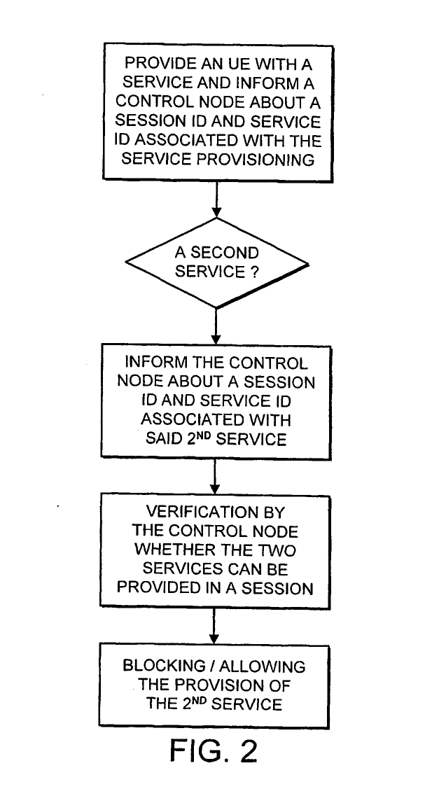

A more detailed example of the operation will now be described with reference to the signalling arrows of FIG. 1 and the flow chart of FIG. 2. In the beginning of the operation service provider SA2 who offers the services based on service architecture #2 contacts (message 1.) the interaction control node 10 to inform it that it is indenting to start a service X and that it belongs to session #2. The controller node checks from the database 11 thereof if session #2 is active. If not, the node marks the session to be active and returns OK to service provider SA2 (message 2.).

Later service provider SA4 employing a service architecture #4 contacts (message 3.) the interaction control node 10 to inform it that it is indenting to start a service Y and that it belongs to session #2. The controller node checks from the database 11 thereof if session #2 is active. Since this is the case, the node checks from the rules if these two services can be provided in a session. The rules do not indicate any restrictions, and thus the node 10 returns OK to service provider SA4 (message 4.).

Later service provider SA3 employing a service architecture #3 contacts (message 5.) the interaction control node 10 to inform it that it is indenting to start a service Z and that it belongs to session #2. As above, the controller node checks if session #2 is active. Since this is the case, the node checks from the rules if this service can be provided in a session wherein services X and Y are already provided. The rules indicate that this is not allowed, and thus the node 10 returns not OK to the service provider SA3 (message 6.) and the service Z cannot be provided in session #2.

The service providers shall use a common practice to name their services. For example, the naming may be based on a global system, e.g. something like the Internet addresses are at the present. For smaller systems it may be more appropriate to use some more lightweight solution such as local identifiers.

The service interaction control node 10 is preferably provided and managed by the operator of the network the user equipment 1 subscribes to. However, the control function may also be run and managed by another service provider such as by a provider of control services offering such services for operators.

In principle a global control entity may be enough. However, in practical implementations the operators may wish to have each their own control facility or a facility shared only with a limited number of operators rather than rely on a global facility.

On the other hand, a master server entity may be provided that masters the service interaction data. This data may then be distributed to local control entities in service architectures dynamically. Thus each session may approach the local control entity that is controlled by the master server. The local entity may communicate with the service providers and the master server to keep the service view up to date.

The service registrations in the interaction control node 10 may be maintained until the service provider informs that the execution of the service has been finished. It is also possible to have a timer functionality such that the registration will lapse after a certain period. The duration of various service execution times may have been studied and the timer function may be adapted to ensure that each of the services has been executed with a certain certainty while it can be ensured that none of the service registrations unnecessarily blocks use of other services. The timer function may monitor the duration times for various services and update the records thereof accordingly.

Instead of simply removing the registration of a service upon expiry of the timer, the interaction control entity may generate and send a message to the service provider and requests the service provider to confirm that at least one of the features of the service is still being executed.

According to an embodiment a service provider may control the timer. This may be advantageous e.g. in situations wherein the service provision last longer than what a default provisioning time is.

According to a possibility the services are grouped based on the characteristics and/or requirements thereof. Execution of a service belonging to a group is not allowed if a service in a conflicting group is already initiated. In this case it is enough if each group of services is provided with a unique identifier.

The rules of the interaction control function can be updated adaptively. For example, if a conflicting situation occurs when two services are run at the same time a rule is added so that these services cannot be run at the same time anymore. The update may be done manually e.g. by the operator, or the system may be arranged to update it automatically in response to a problematic situation caused by conflicting services.

Instead of simply accepting or rejection execution of a service the node 10 may provide more sophisticated control functions. For example, a service may be allowed to be executed but only to the extend that it does not interfere with an already running service.

A possibility is to define priorities between various service or service groups. In such case a later service may have a prioritised status such that executions of a previous conflicting service is either quitted entirely, paused for a while or some features thereof are not allowed until the later service is quitted. An example of such high priority service is an emergency call. Another approach to the prioritisation is based on the price of the services. The operator may also favour services for a certain service provider. The favoured services may be provided by the operator itself, or by a service provider to whom the operator has decided to give beneficial treatment. Services provided in a certain geographic area (e.g. local services depending the location of the user) may also be defined as being more favourable.

A possible rule is that a user may be provided only with a certain number of services at the same time. The limitation may also be such that only one or a limited number of services belonging to a certain group may be run simultaneously. For example, only two IN services may be provided at the same time. It is also possible to define that the user may not use two substantially highly priced services at the same time. A further example of a possible service group is the call forwarding services.

The embodiments may also be employed for controlling the provisioning of a plurality of services within an architecture.

Information associated e.g. with the start time of the service provisioning, any priorities, service lasting time or expiration time and so on may be communicated from a service provisioning entity to the control interaction node as an additional parameter in the message informing the node of the session and service identities.

It shall be appreciated that whilst embodiments of the present invention have been described in relation to a session provided for a mobile station, embodiments of the present invention are applicable to any other suitable type of sessions and user equipment.

It shall also be understood that since the invention makes it easier to provide different service concepts and completely new service concepts by means of new service architectures, these are not limited to the examples discussed above.

It is also noted herein that while the above describes exemplifying embodiments of the invention, there are several variations and modifications which may be made to the disclosed solution without departing from the scope of the present invention as defined in the appended claims.

1. A method in a communication system for provisioning of services, wherein at least two of said services is provided based on different service architectures, the method comprising:
providing a user with a session;
providing a control entity with information identifying the session and information identifying a service to be provided for the user during the session;
processing said identity information at the control entity to verify if information associated with provision of services in the session is stored at the control entity; and
controlling the provision of the service based on the processing.

2. A method as claimed in claim 1, wherein the step of controlling comprises denying provision of the service in the session.

3. A method as claimed in claim 1, wherein said service is to be provided at the same time with provision of at least one other service.

4. A method as claimed in claim 3, wherein one or more of the features of said at least one other service is already being executed at the time when the control entity is provided with said information.

5. A method as claimed in claim 3, wherein said information associated with provision of services comprises rules that are defined by analysing the service and the at least one other service.

6. A method as claimed in claim 3, wherein said information associated with provision of services and stored at the control entity is defined beforehand so that said information indicates a conflicting situation during execution of the service and the at least one other service in the session.

7. A method as claimed in claim 1, wherein said information identifying the service comprises a unique identifier of a service or a group of services.

8. A method as claimed in claim 7, wherein said unique identifier is used globally.

9. A method as claimed in claim 1, wherein the control entity is informed when provisioning of a service of said plurality of services is ended, and wherein said information associated with provision of services is updated accordingly.

10. A method as claimed in claim 1, wherein said information associated with provision of services is updated when a new service is made available for the user or an existing service is changed.

11. A method as claimed in claim 1, wherein the control entity communicates control information with a higher level control entity.

12. A method as claimed in claim 1, wherein a timer function monitors for the duration of the service provisioning.

13. A method as claimed in claim 12, wherein said information associated with provision of services is updated in response to the expiry of said timer function.

14. A method as claimed in claim 12, wherein the control entity sends an enquiry in response to the expiry of said timer function.

15. A method as claimed in claim 12, wherein a service provider sends control instructions for said timer function.

16. A method as claimed in claim 1, wherein said information associated with provision of services is updated adaptively in response to events in a session.

17. A method as claimed in claim 1, wherein the step of controlling comprises denying execution of a feature of the service in the session.

18. A method as claimed in claim 1, wherein said information associated with provision of services in a session comprises information associated with the priority order of said plurality of services.

19. A method as claimed in claim 1, wherein the user communicates over a wireless interface.

20. A method of providing a plurality of services in a communication system for a user of the communication system, the method comprising:
provision each of the services with a unique identifier; and
determining based on information of said unique identifiers if a service can be provided for a user.

21. A method as claimed in claim 20, wherein said step of determining comprises processing information associated with a session in which said service is to be provided.

22. A method as claimed in claim 20, wherein at least two different service architectures is employed in provisioning of the services.

23. A communication system wherein at least two different service architectures are used for provisioning of services for users of the system, comprising:
storage means for storing information that associates with provisioning of services in a session; and
means for processing information that associates with a session provided for a user and information that associates with a service provisioned in said session, wherein said processing means is adapted to verify if such information can be found from the storage means that associates with said session provided for the user and/or said service provisioned in said session.

24. A communication system claimed in claim 23, wherein the arrangement is such that execution of at least a part of the features of a service is prevented if the means for processing information find information that associates with provision of services in said session.

25. A communication system as claimed in claim 23, wherein said information associated with provision of services comprises rules that are defined by analysing the interaction of the services.

26. A communication system as claimed in claim 23, wherein said information associated with provision of services indicates a conflicting situation during simultaneous provision of at least two services in a session.

27. A communication system as claimed in claim 23, wherein each of the services or a group of services is identified by a unique identifier.

28. A communication system as claimed in claim 23, comprising a higher level control entity for provision of control information for said control entity.

29. A communication system as claimed in claim 23 comprising a timer function.

30. A communication system as claimed in claim 23, wherein said storage means are adaptive.

31. A communication system as claimed in claim 23 comprising means for provision of wireless communication for a user of the services.

32. A communication system adapted to provide a plurality of services for a user thereof, wherein the provisioning of at least two of said services is based on different service architectures and each of the services is provided with a unique identifier.
